(19) United States
(12) Patent Application Publication
(10) Pub. No.: US 2007/0288447 A1
(43) Pub. Date: Dec. 13, 2007

(54) System and Method for the Aggregation and Monitoring of Multimedia Data That are Stored in a Decentralized Manner

(75) Inventors: Daniel Andris, Zurich (CH); Leo Keller, Rorbas-Freienstein (CH); Francois Ruef, Zurich (CH)

Correspondence Address: OBLON, SPIVAK, MCCLELLAND MAIER & NEUSTADT, P.C., 1940 DUKE STREET, ALEXANDRIA, VA, 22314, US

(73) Assignee: Swiss Reinsurance Comany, Zurich (CH)

(21) Appl. No.: 10/582,517

(22) PCT Filed: Dec. 9, 2004
(86) PCT No.: PCT/EP04/53384

§ 371 Date: Jun. 1, 2007

(30) Foreign Application Priority Data
Dec. 9, 2003 (CH) CH03/00808

(51) Int. Cl. G06F 17/30

(52) U.S. Cl. 707/5; 707/E17.032

(57) ABSTRACT

System and method for the aggregation and monitoring of locally saved multimedia data, whereby an arithmetic and logic unit accesses network nodes linked with source data banks over a network. In a memory, at least one rating parameter and predetermined source data banks are allocated to one or several search terms. The source data banks are accessed via a filter, and for every rating parameter in connection with a logic combination of search terms and the allocated source data banks, a rating list with detected data records is generated. By means of a parameterization module, the fluctuating mood quantities for the respective rating parameter are at least partly dynamically generated, according to the time-based appearance of the detected data records in specific source data banks and/or categories and/or groups of data banks, whereby the fluctuating mood quantities correspond to the time-based mood fluctuations of users of the networks.

The invention relates to a system and a method for aggregating and analyzing locally stored multimedia data, where a data store is used to store one or more logically combinable search terms, an arithmetic and logic unit uses a network to access network nodes connected to source databases, and data in the source databases are selected on the basis of the search terms. The invention relates particularly to a system and method for realtime analysis of such locally stored multimedia data.

The Internet or the world-wide backbone network is today without doubt one of the most important sources for obtaining information in industry, science and technology and is probably among the most important technical achievements of the outgoing 20th century. It is a fact that today the Internet can be used to access gigantic volumes of data to an extent which was barely conceivable up until 10 years ago. Despite all the resultant advantages, however, it also gives rise to the difficulty of finding actually relevant data in this vast volume of data. Search engines such as the known Internet search engines, for example with the known Altavista engine as a word-based search engine or for example the Yahoo engine as a topic-based search engine, provide the user with the first opportunity to use the large number of local data sources, since without such aids there is a drastic reduction in the prospect of really finding as much of the relevant data as possible. It can be said that the Internet without search engines is like a motor vehicle without an engine. This becomes apparent particularly in the statistical fact that the users of the Internet spend more online time on search engines than anywhere else. Despite all the progress in this area, the search engine technology available in the prior art often does not provide the user with really satisfactory answers, however. As an example, it is assumed that a user wishes to find information about the car model Fiat Uno, for example, e.g. in relation to a liability suit for product liability for a flawed design with technical consequences. General search engines will typically return a large number of irrelevant links for the keyword “Uno” or “Fiat Uno” in this subject, since the search engines cannot identify the context (in this case the legal context) in which the search term is found. It is often also of little use to offer a combination of search terms. One of the reasons for this is that the Internet search engines usually pursue the strategy of “Every document is relevant”, which is why they attempt to capture and index every accessible document. Their manner of operation is always based on this unedited selection of documents. Another drawback of the search engines in the prior art is that the hierarchy of documents found can easily be manipulated by the provider (URL, title, frequency in the content, meta tags etc.), which gives a consumed picture of the documents found. The documents can be classified by the provider perhaps for a few single areas. However, the enormous volume of data and the fact that the information on the network can quickly change (newsgroups, portals etc.) mean that a provider is unable to classify all relevant documents for all the subjects which arise directly or to interpret them in terms of their content. The situation becomes even more difficult if instead of specific subjects, general mood trends, opinion trends or mood fluctuations in the users of the network need to be captured. By way of example, it may be fundamental to the survival of a company or industry (for example tobacco, chemical etc.) to detect the opportunities for a class action (USA) or a liability suit against it using published documents on the Internet in good time and to take appropriate precautions. Particularly for such examples, the traditional search engines cannot be used or can be used only in part. In particular, they do not allow effective realtime monitoring, which may be necessary in such a case.

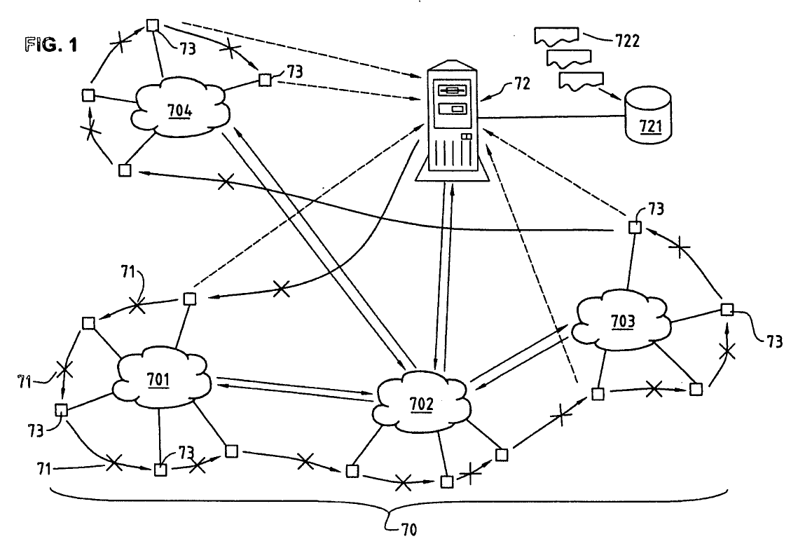

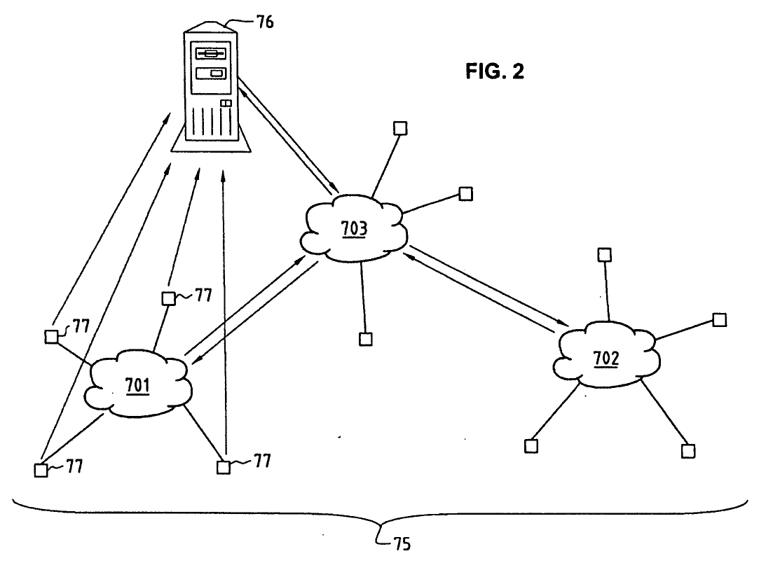

It is important to understand that the term “search engine” in the prior art is usually used for various types of search engines. The available search engines can be coarsely divided into four categories: robots/crawlers, metacrawlers, search catalogs with search options and catalogs or link compendiums. FIG. 1 shows the way in which robots/crawlers work. Search robots or crawlers are distinguished by a process (i.e. the crawler) which moves through the network 70, in this case the Internet 701-704, from network node 73 to network node 73 or from website 73 to website 73 (arrow 71) and in so doing sends back the content of each web document it finds to its host computer 72. The host computer 72 indexes the web documents 722 sent by the crawler and stores the information in a database 721. Each search query (request) by a user accesses the information in the database 721. The crawlers in the prior art normally consider any piece of information to be relevant, which is why all web documents, wherever found, are indexed by the host computer 72. Examples of such robots/crawlers are Google™, Altavista™ and Hotbot™, inter alia. FIG. 2 illustrates the “metacrawlers”. Metacrawlers differ from the robots/crawlers in their ability to search using a single search device 82, the response additionally being produced by a large number of other systems 77 in the network 75. The metacrawler is therefore used as a frontend for a large number of further systems 77. The response to a search request from a metacrawler is typically limited by the number of its further systems 77. Examples of metacrawlers are Metacrawler™, LawCrawler™ and LawRunner™, inter alia. Catalogs with or without search options are distinguished by a special selection of links which are constructed and/or organized manually and stored in an appropriate database. In the case of a catalog with search options, a search request prompts the system to search the manually stored information for the desired search terms. In the case of a catalog without search options, the user has to look for the desired information himself in the list of stored links, for example by clicking or scrolling through the list manually. In the latter case, the user himself decides what information from the list appears relevant to him and what information appears less relevant to him. Catalogs are naturally limited by the volume of output and the priorities of the editor(s). Examples of such catalogs are Yahoo!™ and FindLaw™, inter alia. Catalogs come under the category of portals and/or vortals. Portals and, to a certain extent, also proprietary databases such as FindLaw.com™ or WestLaw.com™, for example, attempt to solve the problem in different ways. Portals attempt to obtain an overview of selected computer sites manually by allowing editors to “surf” the Internet, i.e. to assess the content, and compile relevant data sources or sites. The editors are able to search, read and evaluate approximately 10-25 sites on average per day, with usually only 1 or 2 sites from 25 containing documents with the desired quality or information. It becomes clear that portals are very inefficient for the provider in terms of time, cost and work involvement if the aim of a portal is to be a comprehensive indexing mechanism for all available data relating to a subject on the Internet. For this reason, it is usually the case that Internet portals also just specify links to the start/main pages of the various sites. Since the data provided on the Internet is subject to a wide dynamic range, it can even be said that this method will hardly ever permit all available data to be captured completely and in up-to-date fashion. Vertical portals, known as vortals, are understood generally to mean portals which limit their provision for such selection of information to a particular area. Vortals therefore intrinsically have the same drawbacks as the portals discussed above. In contrast, the aforementioned drawbacks appear even more in the foreground in the case of vortals, since their subject limitation makes the demand on quality and accuracy of the indexing mechanism much higher. This makes the task of searching, reading and assessing a critical mass of information even more difficult and even more time-consuming. An example of such a vortal is FindLaw.com™, inter alia, which has been provided and developed since 1995.

The search engines in the prior art usually comprise a crawler and an input option (frontend query) for a user. Typically, the search engines also comprise a database with stored links to various web documents or sites. The crawler selects a link, downloads the document and stores it in a data store. It then selects the next link and likewise loads the document into the data store etc. etc. An indexing module reads one of the stored documents from the data store and analyzes its content (e.g. on a word basis). If the indexing module finds further links in the document, it stores them in the crawler's database, which means that the crawler can later likewise load the relevant documents into the data store. The way in which the content of the document is indexed is dependent on the respective search engine. The indexed information can be stored in a hash table or other suitable tool, for example, for later use. A user can now input a search request using the frontend and the search engine looks for the appropriate indexed pages. The process is based on the “Everything is relevant” principle, which means that the crawler will fetch and store any web document which can be accessed in any way. Complex, content-oriented queries cannot be carried out using today's search engines without their either excluding relevant documents or also indicating a flood of documents which are irrelevant to the query. Particularly in the case of search queries where subjects are to be indexed on the basis of non-subject-related, indistinctly tangible parameters, the search engines hardly ever also give just approximately satisfactory responses. As mentioned, an example which may be cited in this regard is the eminently important problem for industry that generally mood trends, opinion trends or mood fluctuations in the users of the network need to be detected for a specific subject. This cannot be done on the basis of today's search engines. Similarly, the search engines in the prior art have to date not at all been able to be used to identify moods and mood fluctuations in the network users in relation to a subject in good time and to specify the appropriate documents.

US patent application US2003/0195872 discloses a system which can be used to link search terms to emotional rating terms and to perform a search on the Internet and/or an intranet on the basis of this association between search terms and emotional rating terms. However, the system does not allow targeted screening of databases. In particular, the system cannot be used to make any time-based statements. This prevents or precludes any objective assessment of trends or events which are to be expected. The system merely allows static listing of documents stored in the available databases. Hence, all relevant documents in this system actually need to be read and interpreted more or less completely after the listing, which precludes any automation for the purpose of a dynamic warning system, for example.

It is an object of this invention to propose a novel system and a method for aggregating and analyzing locally stored multimedia data which do not have the aforementioned drawbacks of the prior art. In particular, the intention is to propose an automated, simple and rational system and method of making complex, content-oriented queries. The query is intended to allow, in particular, non-subject-related and/or indistinctly tangible parameters, such as moods or mood fluctuations in the network users, as filter parameters. Conversely, the inventive method and system are likewise intended to allow moods and mood fluctuations in the network users for a subject to be identified in good time and the appropriate documents to be specified.

On the basis of the present invention, this aim is achieved particularly by the elements of the independent claims. Further advantageous embodiments can also be found in the dependent claims and in the description.

In particular, these aims are achieved by the invention by virtue of locally stored multimedia data being aggregated and monitored and/or analyzed by using a data store to store one or more logically combinable search terms, an arithmetic and logic unit using a network to access network nodes connected to source databases, and data in the source databases being selected on the basis of the search terms, by virtue of a data store being used to store at least one rating parameter in association with a search term and/or a logic combination of search terms, by virtue of the data store being used to store at least one of the source databases in association with a search term and/or with a logic combination of search terms, by virtue of a filter module in the arithmetic and logic unit being used to access the source databases at the network nodes, and a rating list containing data records which have been found being produced for each rating parameter in conjunction with the associated search terms and the associated source databases and/or a time-based rating for the documents, and by virtue of a parameterization module being used to generate, at least to some extent dynamically, a variable mood quantity on the basis of the rating list for the respective rating parameter, which variable mood quantity corresponds to time-based, positive and/or negative mood fluctuations in users of the network. To generate the variable mood quantities and/or the data in the content module, for example, the arithmetic and logic unit may comprise an HTML (Hyper Text Markup Language) and/or HDML (Handheld Device Markup Language) and/or WML (Wireless Markup Language) and/or VRML (Virtual Reality Modeling Language) and/or ASP (Active Server Pages) module. This variant embodiment has, inter alia, the advantage that the system is based on a totality of sources, specifically definable in advance, from a network, particularly from the Internet (e.g. websites, chat rooms, e-mail forums etc.), which are likewise scanned on the basis of search criteria definable in advance. The system therefore allows not only the generation of a “hits list” of websites found on the Internet which have appropriate content, but rather the system allows the aforementioned screening of predefinable sources and their systematic and hence quantitatively relevant evaluation in line with the desired and defined content criteria (e.g. what medicaments are mentioned in connection with serious side-effects—and what the frequency of these is). This content screening can be performed in a periodic sequence (over time), with all the “hits” contents found being able to be made available again and hence statistical statements being possible, particularly over time. Naturally, the documents can also be detected otherwise in relation to their time-based association, e.g. on the basis of the storage date. The system also recognizes when what content has been stored in said sources. The fact that this allows a quantitative evaluation means that the system is able to ‘monitor’ the defined sources automatically and to show accordingly when a ‘threshold value’ has been exceeded (quantitatively). The system allows search criteria to be defined such that it is possible to look for a (meaningful) logical relationship in the contents (not only the keyword counts, but rather a content relationship). The system therefore links the search criteria to a content, and a search is then carried out for these.

In one variant embodiment, one or more of the rating parameters are generated using a lexicographical rating database. The same can be done for the search terms. This variant embodiment has, inter alia, the advantage that search and rating terms can be defined on a user-specific and/or application-specific basis. As a variant embodiment, the lexicographical rating database and/or search term database can be supplemented and/or altered dynamically on the basis of searches/analyses which have already been performed. This allows the system to be automatically matched to altered conditions and/or word formations, which was not possible in this manner in the prior art.

In another variant embodiment, one or more of the rating parameters are generated dynamically using the arithmetic and logic unit while the rating list is being produced. This variant embodiment has, inter alia, the same advantages as the preceding variant embodiments.

In another variant embodiment, the rating list containing the data records found and/or references to the data records found is stored in a content module in the arithmetic and logic unit so as to be accessible to a user. This variant embodiment has, inter alia, the advantage that the system can be used as a warning system for the user, for example, which informs and/or warns him of imminent trends in the market or in the population (e.g. class actions etc.).

In one variant embodiment, the mood quantities are periodically checked using the arithmetic and logic unit, and if at least one of the mood quantities is situated outside of a definable fluctuation tolerance or determinable expected value then the relevant rating list containing the data records found and/or references to data records which have been found is stored and/or updated in the content module in the arithmetic and logic unit so as to be accessible to a user. This variant embodiment has, inter alia, the advantage that the databases can be scanned in targeted fashion for time-based alterations or events which are to be expected, e.g. using a definable probability threshold value, and in this way can warn the user in good time, for example (e.g. product faults, product liability etc.).

In yet another variant embodiment, a user profile is created using user information, with a repackaging module being used, taking into account the data in the user profile, to produce data optimized for specific users on the basis of the data records found and/or references to data records which have been found which are stored in the content module, said data optimized for specific users being made available to the user in a form stored in the content module in the arithmetic and logic unit. As a variant embodiment, various user profiles for different communication apparatuses of the user can be stored in association with the user. In addition, data relating to the user behavior, for example, can also be automatically captured by the arithmetic and logic unit and stored in association with the user profile. This variant embodiment has, inter alia, the advantage that different access options for the user can be taken into account for specific users and the system can thus be optimized for specific users.

In one variant embodiment, a history module is used to store the values for each calculated variable mood quantity up to a definable time in the past. This variant embodiment has, inter alia, the same advantages of time-based control and detection of alterations within the stored and accessible documents.

In another variant embodiment, the arithmetic and logic unit uses an extrapolation module to calculate expected values for a determinable mood quantity on the basis of the data in the history module for a determinable time in the future and stores them in a data store in the arithmetic and logic unit. This variant embodiment has, inter alia, the advantage that events to be expected can be predicted automatically. This may be appropriate not only in the case of warning systems (e.g. against class actions for product liability etc.) but also quite generally in the case of systems in which statistical/time-based extrapolation is important, such as in the case of a risk management system on the stock exchange or financial markets etc.

At this juncture, it should be stated that the present invention relates not only to the inventive method but also to a system for carrying out this method. In addition, it is not limited to said system and method, but likewise relates to a computer program product for implementing the inventive method.

Variant embodiments of the present invention are described below with reference to examples. The examples of the embodiments are illustrated by the following appended figures:

FIG. 1 schematically shows the way in which robots/crawlers, search robots or crawlers work. The crawler moves through the network 70, in this case the Internet 701-704, from network node 73 to network node 73 or from website 73 to website 73 (arrow 71) and in so doing returns the content of each web document it finds to its host computer 72. The host computer 72 indexes the web documents 722 sent by the crawler and stores the information in a database 721. Each search query (request) by a user accesses the information in the database 721.

FIG. 2 schematically illustrates the way in which metacrawlers work. Metacrawlers afford the opportunity to search using a single search device 82, the response additionally being produced by a large number of further systems 77 in the network 75. The metacrawler therefore serves as a frontend for a multiplicity of further systems 77. The response to a search request from a metacrawler is typically limited by the number of its further systems 77.

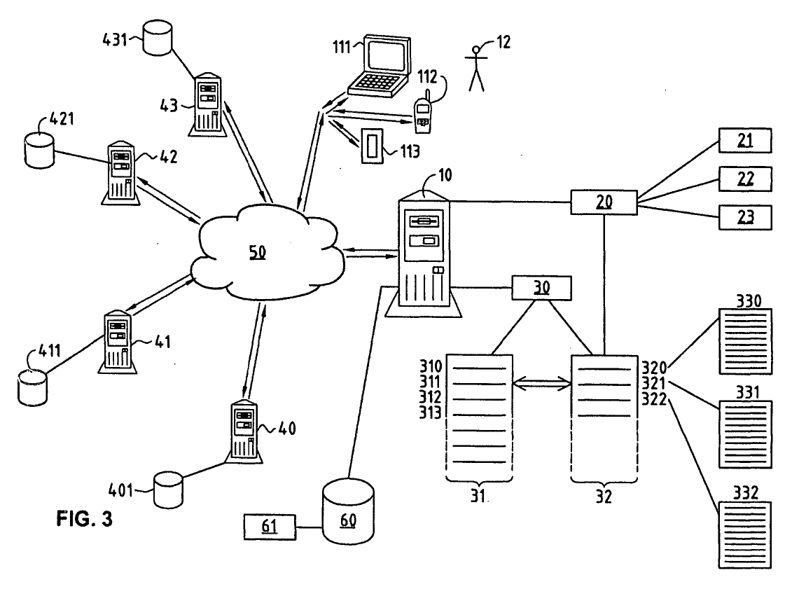

FIG. 3 shows a block diagram which schematically shows a system and a method for aggregating and analyzing locally stored multimedia data. A data store 31 is used to store one or more logically combinable search terms 310, 311, 312, 313. An arithmetic and logic unit 10 uses a network 50 to access network nodes 40, 41, 42, 43 connected to source databases 401, 411, 421, 431, and data in the source databases 401, 411, 421, 431 are selected on the basis of the search terms 310, 311, 312, 313.

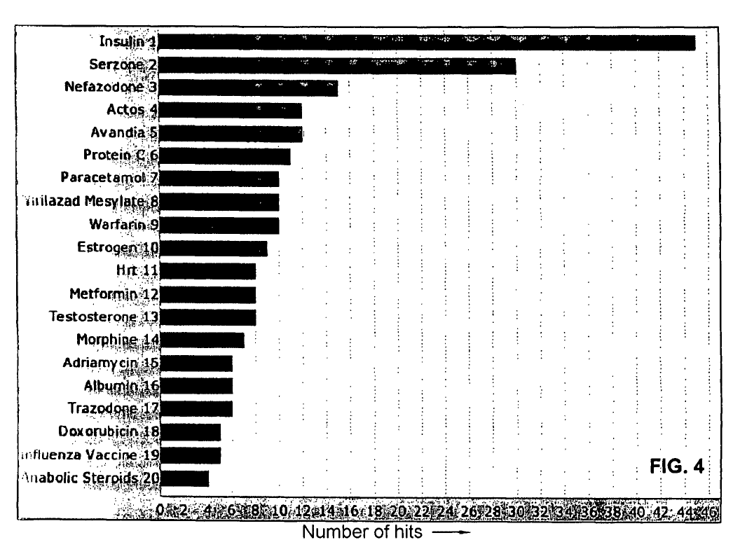

FIG. 4 shows an example of a possible result in the case of a medical and/or pharmaceutical monitoring system based on medicaments as a function of their hits list in the documents.

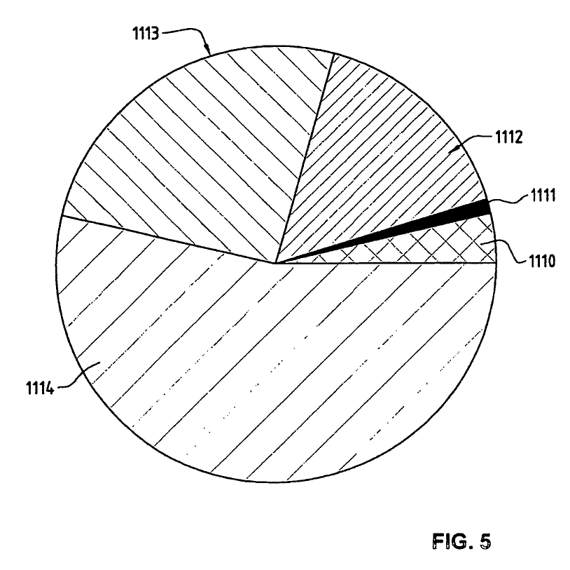

FIG. 5 likewise shows an example of a possible result in a medical and/or pharmaceutical monitoring system of this kind, for example for a medicament in connection with illnesses and/or causes of death which arise.

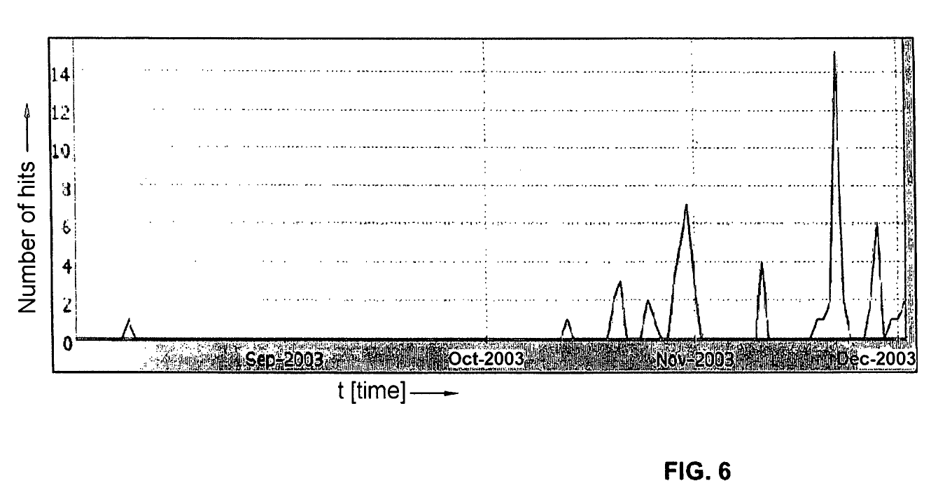

FIG. 6 uses the same variant embodiment as FIGS. 4 and 5 to show the occurrence, detected over time, using the example of Serzone in the documents in the available and/or determined source databases 401, 411, 421, 431.

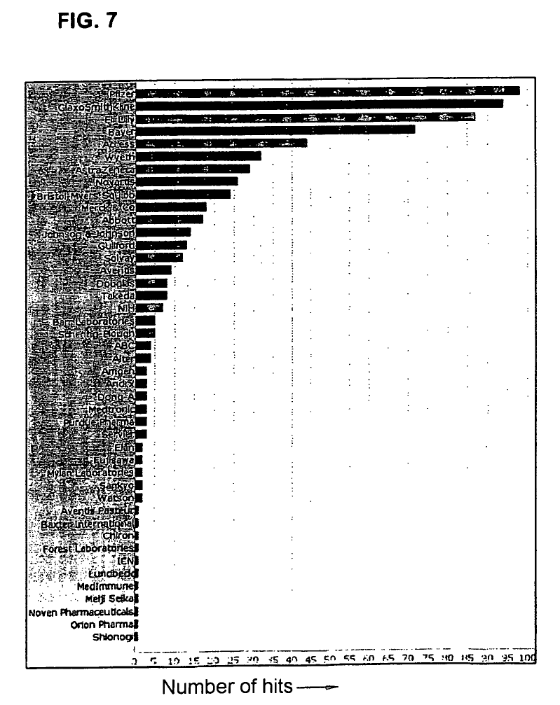

FIG. 7 shows an exemplary listing of companies (in this case, by way of example, law firm pages etc.) as a function of a selection of rating and/or search terms 310, 311, 312, 313 (in this case, by way of example, industrial names) and their number of hits in the documents.

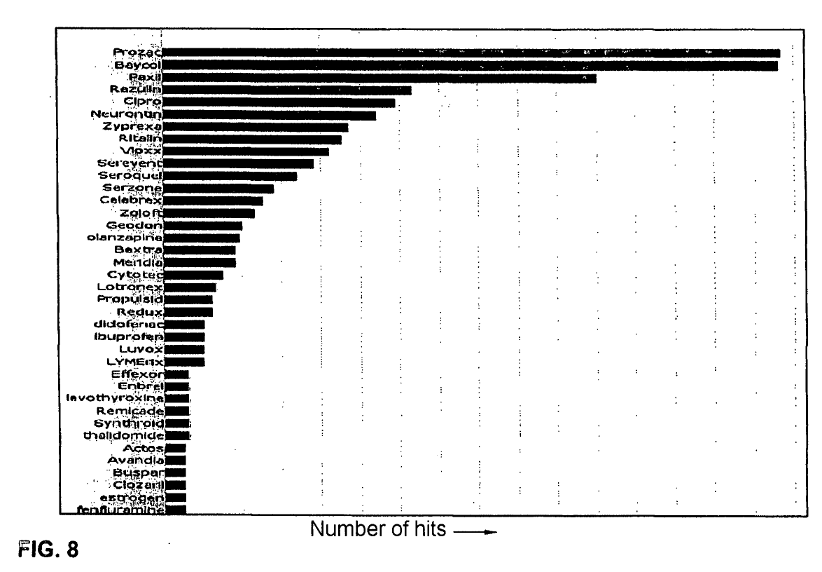

FIG. 8 likewise shows an exemplary listing of companies (in this case, by way of example, law firm pages etc.) as a function of a selection of rating and/or search terms 310, 311, 312, 313 (in this case, by way of example, pharmaceutical products) and their number of hits in the documents.

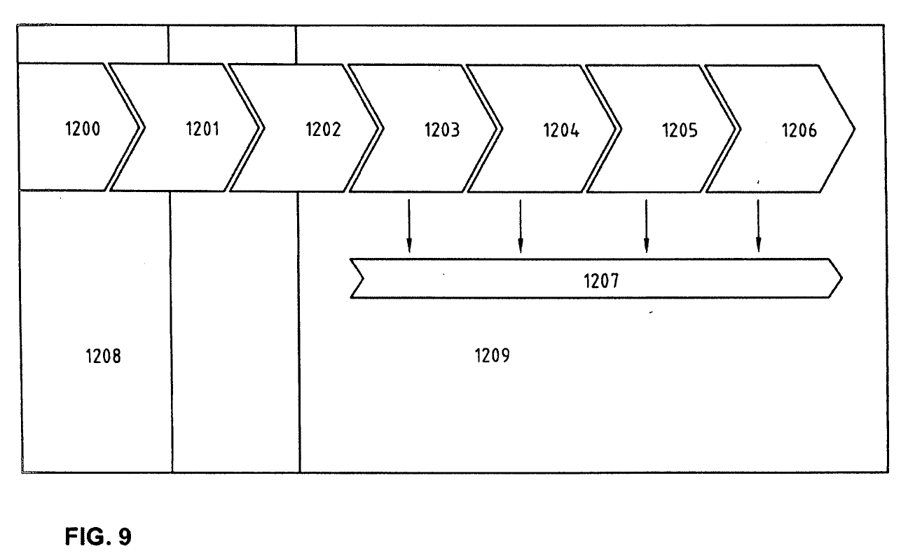

FIG. 9 shows the timing for an event which may result in a class action against a company. The specification of the system in line with this sequence thus allows, by way of example, time-based monitoring and warning of the user about a possible and/or probable class action.

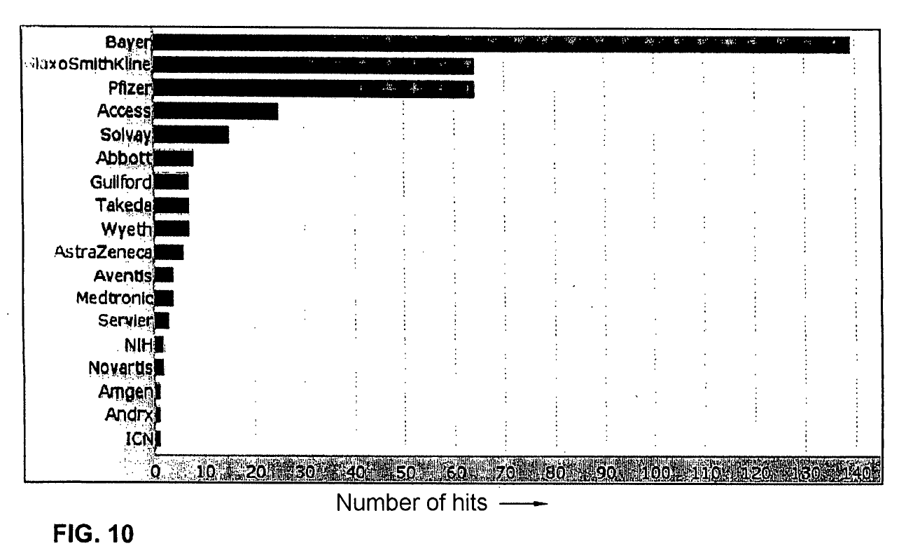

FIG. 10 shows the listing of company names as a function of rating terms, such as suit etc., and their number of hits in messages or e-mails in a forum.

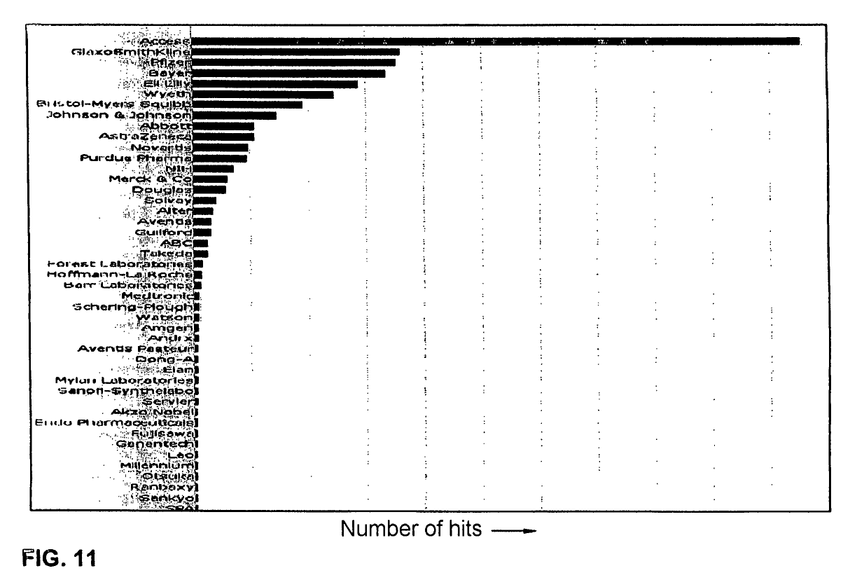

FIG. 11 shows the listing in the same variant embodiment as in FIG. 10, generally on the basis of company names.

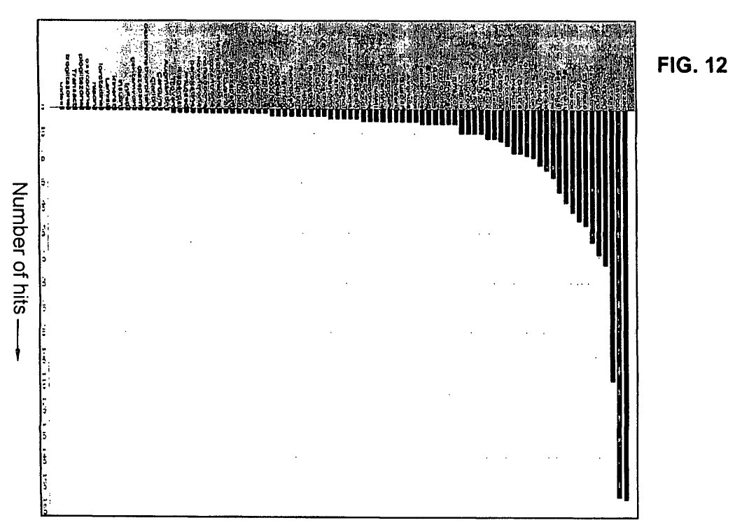

FIG. 12 shows the listing in the same variant embodiment as in FIGS. 10 and 11 on the basis of rating terms, such as pharmaceutical products.

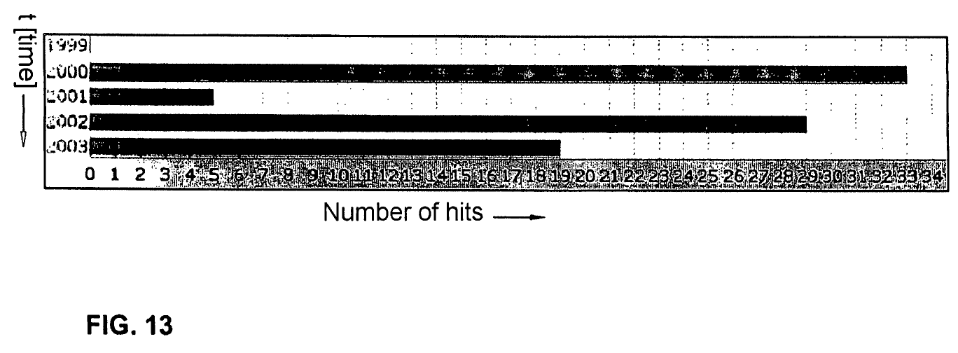

FIG. 13 shows a listing of the time-based fluctuation in the aggregation and/or analysis of the documents which is performed using the system.

FIG. 1 schematically illustrates an architecture which can be used for implementing the invention. In this exemplary embodiment, locally stored multimedia data are aggregated and analyzed by storing one or more logically combinable search terms 310, 311, 312, 313 in a data store 31. Multimedia data are to be understood, inter alia, to mean digital data such as text, graphics, pictures, maps, animations, moving pictures, video, Quicktime, sound recordings, programs (software), program-accompanying data and hyperlinks or references to multimedia data. These also include, by way of example, MPx (MP3) or MPEGx (MPEG4 or 7) standards, as defined by the Moving Picture Experts Group. In particular, the multimedia data may comprise data in HTML (Hyper Text Markup Language), HDML (Handheld Device Markup Language), WMD (Wireless Markup Language), VRML (Virtual Reality Modeling Language) or XML (Extensible Markup Language) format. An arithmetic and logic unit 10 uses a network 50 to access network nodes 40, 41, 42, 43 connected to source databases 401, 411, 421, 431, and data in the source databases 401, 411, 421, 431 are selected on the basis of the search terms 310, 311, 312, 313. In line with the present invention, the arithmetic and logic unit 10 is connected to the network nodes 40, 41, 42, 43 bidirectionally via a communication network. By way of example, the communication network 50 comprises a GSM or UMTS network, or a satellite-based mobile radio network, and/or one or more landline networks, for example the public switched telephone network, the worldwide Internet or a suitable LAN (Local Area Network) or WAN (Wide Area Network). In particular, it also comprises ISDN and XDSL connections. The multimedia data can, as illustrated, be stored at different locations in different networks or locally so as to be accessible to the arithmetic and logic unit 10. The network nodes 40, 41, 42, 43 may comprise WWW servers (HTTP: Hyper Text Transfer Protocol/WAP: Wireless Application Protocol etc.), chat servers, e-mail servers (MIME), news servers, E-journal servers, group servers or any other file servers, such as FTP servers (FTP: File Transfer Protocol), ASD (Active Server Pages) based servers or SQL based servers (SQL: Structured Query Language) etc.

A data store 32 in the arithmetic and logic unit 10 is used to associate and store at least one rating parameter 320, 321, 322 with a search term 310, 311, 312, 313 and/or with a logic combination of search terms 310, 311, 312, 313. The search term 310, 311, 312, 313 and/or a logic combination of search terms 310, 311, 312, 313 comprises the actual search term. To come back to the aforementioned example of the Fiat Uno, the search term 310, 311, 312, 313 and/or a logic combination of search terms 310, 311, 312, 313 would consequently be, by way of example, Fiat, Fiat Uno, Fiat AND/OR Uno FIAT etc. By contrast, the rating parameters 320, 321, 322 comprise the rating subject, e.g. class action, court case etc. with appropriate rating attributes. The rating attributes may be specific to a rating subject, e.g. damage, liability, insurance sum or may comprise quite general rating assessments such as “good”, “poor”, “fierce” etc., i.e. psychological or emotional attributes or words, for example, which permit an association of this kind. It is important to point out that the rating parameters 320, 321, 322 may also comprise restrictions regarding the network 50 and/or specific network nodes 40-43. As an example, this allows the aggregation and analysis of the multimedia data to be restricted to particular newsgroups and/or websites using appropriate rating parameters 320, 321, 322, for example. In this exemplary embodiment, one or more of the rating parameters 320, 321, 322 can be generated using a lexicographical or other rating database. Similarly, it may be appropriate for the or a plurality of rating parameters 320, 321, 322 to be generated, at least to some extent dynamically, using the arithmetic and logic unit 10 while the rating list 330, 331, 332 is being produced. By way of example, dynamically can mean that the parameterization module 20 or the filter module 30 checks the multimedia data and/or the data in the rating list 330, 331, 332 in a form associatable on the basis of a rating parameter 320, 321, 322 during indexing and/or at a later time in the method and adds them to the rating parameters 320, 321, 322. In this case, it may be appropriate for the rating parameters 320, 321, 322 to be able to be edited by the user 12. For the dynamic reduction, it may be appropriate to have particularly analysis modules, for example, based on neural network algorithms.

The data store 32 can be used to store at least one of the source databases 401, 411, 421, 431 in association with a search term 310, 311, 312, 313 and/or with a logic combination of search terms 310, 311, 312, 313. The association may comprise not only explicit network addresses and/or references from databases, but also categories and/or groups of databases, such as websites, chat rooms, e-mail forums etc. etc.). The associations can be made automatically, partly automatically, manually and/or on the basis of a user profile and/or or other user-specific and/or application-specific data. The arithmetic and logic unit 10 uses a filter module 30 to access the source databases 401, 411, 421, 431 at the network nodes 40, 41, 42, 43, and produces a rating list 330, 331, 332 containing data records which have been found for each rating parameter 320, 321, 322 in conjunction with the associated search terms 310, 311, 312, 313 and/or source databases 401, 411, 421, 431. It is immediate to a person skilled in the art that the rating subject must not necessarily be handled with the same importance as the rating attributes during indexing. To produce the rating list 330, 331, 332 based on the multimedia data, it is possible to generate or aggregate metadata, for example, based on the content of the multimedia data, using a metadata extraction module in the arithmetic and logic unit 10. That is to say that the rating list 330, 331, 332 can therefore comprise metadata of this kind. The metadata or quite generally the data in the rating list 330, 331, 332 can be extracted using a content-based indexing technique, for example, and can comprise keywords, synonyms, references to multimedia data (e.g. including hyperlinks), picture and/or sound sequences etc. Such systems are known in the prior art in many different variations. Examples of these are US patent specification U.S. Pat. No. 5,414,644, which describes a three-file indexing technique, or US patent specification U.S. Pat. No. 5,210,868, which additionally also stores synonyms as search keywords when the multimedia data are indexed and the metadata are extracted. In the present exemplary embodiment, the metadata may alternatively be produced, at least to some extent dynamically (in realtime), on the basis of user data in a user profile. This has the advantage, for example, that the metadata always have the levels of currency and accuracy which are useful to the user 12. From the user behavior on the communication apparatus 111, 112, 113 to the metadata extraction module, there is therefore a kind of feedback option which can influence the extraction directly. Alternatively, particularly when searching for particular data, it is possible to use “agents”.

Said user profile can be created using user information, for example, and can be stored in the arithmetic and logic unit 10 in association with the user 12. The user profile either remains stored permanently in association with a particular user 12 or is created temporarily. The user's communication apparatus 11/112/113 may be a PC (Personal Computer), TV, PDA (Personal Digital Assistant) or a mobile radio (e.g. particularly in combination with a broadcast receiver), for example. The user profile may comprise information about a user, such as location of the user's communication unit 111/112/113 in the network, identity of the user, user-specific network properties, user-specific hardware properties, data relating to the user behavior etc. The user 12 can stipulate and/or modify at least portions of user data in the user profile in advance of a search query. Naturally, the user 12 always retains the opportunity to look for and access multimedia data by means of direct access, that is to say without any searching and compiling assistance from the arithmetic and logic unit 10, in the network. The remaining data in the user profile can be automatically determined by the arithmetic and logic unit 10, by authorized third parties or likewise by the user. Thus, the arithmetic and logic unit 10 may comprise, by way of example, automatic connection recognition, user identification and/or automatic recording and evaluation of the user behavior (time of access, frequency of access etc.). These data relating to the user behavior can then, in one variant embodiment, in turn be modifiable by the user in line with his requirements.

A parameterization module 20 is used to generate, at least to some extent dynamically, a variable mood quantity 21 for the respective rating parameter 320, 321, 322, on the basis of the rating list 330, 331, 332. To generate the variable mood quantities 21 and/or the data in the content module 60, it is possible to use HTML and/or HDML and/or WML and/or VRML and/or ASD, for example. The variable mood quantity 21 corresponds to positive and/or negative mood fluctuations in users of the network 50. The variable mood quantity 21 can also be specific to a rating subject. By way of example, the variable mood quantity 21 may show the probability of a class action against a particular company and/or a particular product or just a general usefulness classification for a medicament, for example, from the users or from a specific subgroup, such as doctors and/or other specialist medical personnel. As an exemplary embodiment, the rating list 330, 331, 332 containing the data records found and/or references to data records found may be stored in a content module 60 in the arithmetic and logic unit 10 so as to be accessible to a user. To be able to access the content module 60, it may be appropriate (e.g. in order to charge for the service used) to identify a particular user 12 of the arithmetic and logic unit 10 using a user database. For identification purposes, it is possible to use personal identification numbers (PIN) and/or “smartcards”, for example. Smartcards normally require a card reader on the communication apparatus 111/112/113. In both cases, the name or another identification for the user 12 and also the PIN is transmitted to the arithmetic and logic unit 10 or to a trusted remote server. An identification module or authentication module decrypts (if required) and checks the PIN using the user database. As a variant embodiment, credit cards can likewise be used for identifying the user 12. If the user 12 uses his credit card, he can likewise input his PIN. Typically, the magnetic strip on the credit card contains the account number and the encrypted PIN of the authorized holder, i.e. in this case the user 12. The decryption can take place directly in the card reader itself, as is usual in the prior art. Smartcards have the advantage that they allow a greater level of security against fraud through additional encryption of the PIN. This encryption can either be performed by a dynamic numerical key containing the time, day or month, for example, or by another algorithm. The decryption and identification are not performed in the appliance itself, but rather externally using the identification module. Another option is for a chip card to be inserted directly into the communication apparatus 111/112/113. The chip card may be SIM (Subscriber Identification Module) cards or smartcards, with the chip cards having a respective associated telephone number. The association can be made using an HLR (Home Location Register), for example, by virtue of the IMSI (International Mobile Subscriber Identification) being stored in the HLR in association with a telephone number, e.g. an MSISDN (Mobile Subscriber ISDN). This association then allows clear identification of the user 12.

To start a search query, a user 12, for example, uses a frontend to transmit a search request for the relevant query from the communication apparatus 111/112/113 to the arithmetic and logic unit via the network 50. The search request data can be input using input elements on the communication apparatus 111/112/113. The input elements may comprise keypads, graphical input means (mouse, trackball, eyetracker in the case of a virtual retinal display (VRD) etc.) or else IVR (Interactive Voice Response) etc., for example. The user 12 has the option of determining at least a portion of the search request data himself. This can be done, by way of example, by virtue of the user being asked by the reception apparatus 111/112/113 to fill in an appropriate frontend query using an interface. The frontend query may comprise, in particular, additional authentication and/or charges for the query. The arithmetic and logic unit 10 checks the search request data and, if they meet determinable criteria, the search is executed. To obtain the best possible level of currency for the data or to achieve permanent monitoring of the network, the mood quantities 21 can be periodically checked using the arithmetic and logic unit 10, for example, and if at least one of the mood quantities 21 is situated outside of a definable fluctuation tolerance or a determinable expected value then the relevant rating list 330, 331, 332 containing the data records found and/or references to data records which have been found can be stored and/or updated in the content module 60 in the arithmetic and logic unit 10 so as to be accessible to a user. For user-specific requests, it may be appropriate for a user profile to be created using user information, for example, with a repackaging module 61 being used, taking into account the data in the user profile, to produce data optimized for specific users, for example on the basis of the data records found and/or references to data records which have been found which are stored in the content module 60. The data optimized for specific users can then be made available to the user 12, for example, in a form stored in the content module 60 in the arithmetic and logic unit 10. It may be advantageous for various user profiles to be stored in association with a user 12 for different communication apparatuses 111, 112, 113 of this user 12. For the user profile, it is also possible for data relating to the user behavior to be captured automatically by the arithmetic and logic unit 10, for example, and to be stored in association with the user profile.

It is important to point out that, as a variant embodiment, a history module 22 can be used to store the values for each calculated variable mood quantity 21 up to a definable time in the past. This allows, by way of example, the arithmetic and logic unit 10 to use an extrapolation module 23 to calculate expected values for a determinable mood quantity 21 on the basis of the data in the history module 22 for a determinable time in the future and to store them in a data store in the arithmetic and logic unit 10. The user 12 is therefore not only able to be informed about current mood fluctuations or mood alterations, but can also access expected values for future behavior of the users in the network and can set himself accordingly.

FIGS. 4 to 8 show a variant embodiment for opinion monitoring for pharmaceutical and/or medical products and for warning the company about imminent product liability cases and/or class actions or other court cases. The variant embodiment is intended to permit realtime monitoring of the public discussion for side-effects and/or ancillary actions of a medicament or pharmaceutical product, e.g. in the worldwide backbone network, the Internet. In one example, the variant embodiment has been used to monitor more than 2500 medicaments and pharmaceutical products in more than 10 000 public (public topic related) news channels on the Internet. This had not been possible to date in the prior art. In this example, the side-effects used were liver damage, kidney damage, cardiac damage, brain damage, medicament-induced depression with suicidal consequences and also allergic reactions as rating terms and/or search combination terms in connection with the medicament and/or pharmaceutical product.

FIG. 4 shows an example of one of the results of the medical and/or pharmaceutical monitoring system based on medicaments as a function of their hits list in the documents. FIG. 5 likewise shows an example of one of the results or intermediate results in a system of a medicament in connection with illnesses and/or causes of death which occur. The reference number 1110 corresponds to liver damage at 3.9% with 11 locations assessed as relevant by the system in this context in the documents. The reference number 1111 corresponds to kidney damage at 1.1% with 3 locations assessed as relevant by the system in the documents. The reference number 1112 corresponds to cardiac damage at 16.1% with 46 locations assessed as relevant by the system in the documents. The reference number 1113 corresponds to brain damage at 25.3% with 72 locations assessed as relevant by the system in the documents. The reference number 1114 corresponds to depression-related suicides at 53.7% with 153 locations assessed as relevant by the system in the documents. FIG. 6 shows, in the same variant embodiment as in FIGS. 4 and 5, the occurrence detected over time using the example of the medicament Serzone in the documents in the available and/or determined source databases 401, 411, 421, 431. Evidence of the relevance was present in all the documents found. With the system, therefore, new data sources also be found dynamically, for example. In particular, the system may be used as an early warning system for companies. Multilingual ratings and/or analyses can likewise be performed using the system, for example, inter alia by virtue of adaptations (e.g. manually/automated and/or dynamically by the system etc.) in the rating and/or search term databases etc. The monitoring can easily be extended to imminent and/or expected class actions and/or other court disputes, e.g. based on product liability, using the inventive system by monitoring law firm pages and/or public pages relating to legal problems, in particular, periodically or at staggered times. FIG. 7 shows an exemplary listing of companies (e.g. in this case law firm pages etc.) as a function of a selection of rating and/or search terms 310, 311, 312, 313 (e.g. in this case industrial names) and their number of hits in the documents in this exemplary embodiment. FIG. 8 likewise shows a listing of this type for companies (e.g. in this case law firm pages etc.) as a function of a selection of rating and/or search terms 310, 311, 312, 313 (e.g. in this case pharmaceutical products) and their number of hits in the documents.

FIGS. 9 to 13 show an exemplary embodiment of an early warning system for imminent class actions or other legal disputes against companies. To set up a system of this kind, e.g. for monitoring one or more products from a company, in appropriate fashion it may be useful to understand the process in its fundamental steps. FIG. 9 shows the timing for an event which can result in a class action against a company. The reference numbers 2008 and 2009 comprise 2 time stages in the sequence before a class action is submitted. In 2008, a first discussion about side-effects of a product arises in the public or in the particular forum. At this time, an early warning to the company in question may be important. In 2009, the legal and juridical discussion starts in the forums (e.g. juridical websites etc.), which ultimately results in the class action being submitted. At this time, a juridical warning to the company may be important to survival. 1200 is the early start about ancillary actions and/or side-effects of a product, e.g. in public e-mail forums and/or newsgroups. 1201 is the time at which a first discussion starts about legal aspects in the forums. In 1202, legal steps start to be prepared. In 1203, initial demands, such as claims for damages, are sent to the company. In 1204, the class action is submitted against the company. In 1205, the class action is either admitted by the court or is rejected for legal reasons. In 1206, the judgment by the court authorities is finally made in this case. During 1203, 1204, 1205 or 1206, the parties can at any time make an out-of-court agreement or settlement in this matter at 1207, which would end the discussion. A legal development of this kind can be achieved, by way of example, by monitoring juridical forums and law firm websites etc. These forums and websites therefore become predetermined source databases 401, 411, 421, 431. In this exemplary embodiment, the inventive system has monitored, by way of example, 15 000 websites from attorneys, 2500 products from companies and 450 manufacturers of pharmaceutical products. This could not be done in this way in the prior art. The specification of the system is based on the sequence shown in FIG. 9 and thus allows, by way of example, monitoring over time and the user to be warned about a possible and/or probable class action. FIG. 10 shows the listing of company names as a function of rating terms such as suit etc. and/or products and their number of hits in messages or e-mails in a forum. FIG. 11 shows the listing in the same variant embodiment as in FIG. 10 generally on the basis of company names. FIG. 12 shows the listing in the same variant embodiment as in FIGS. 10 and 11 on the basis of rating terms such as pharmaceutical products. FIG. 13 shows a listing for the fluctuation over time in the documents' aggregation and/or analysis before using the system. The relevance or correlation of the graph bars shown with the events has been able to be shown in all cases for the inventive system. In the prior art, it is not currently possible to find a comparable automated system for monitoring and/or early warning/recognition.

1-24. (canceled)

25. A method for aggregating and monitoring locally stored multimedia data, comprising:
saving, in a first memory, at least one search term;
accessing over a network, by an arithmetic and logic unit, network nodes connected to source databases;
selecting data of the source databases based on the at least one search term;
saving, in a second memory, at least one rating parameter in association with the at least one search term;
determining and saving, in the second memory, at least one of the source databases in association with the at least one search term, the association including categories and/or groups of databases;
accessing the source databases of the network nodes using a filter module of the arithmetic and logic unit, for every rating parameter in connection with the at least one search term and the source databases, to generate a rating list of detected data records corresponding to the at least one associated search term and the at least one rating parameter; and
generating, based on the rating list and using a parameterization module, variable mood quantities corresponding to time-based mood fluctuations in users of the network, based on the detected data records.

26. The method of claim 25, further comprising:
triggering a time-based entry and/or a probability of a time-based entry of an expected incident, based on the time-based mood fluctuations of the detected data records in at least one of the source databases, categories, and groups of databases.

27. The method of claim 26, wherein the expected incident includes an expected class action.

28. The method of claim 25, further comprising:
saving the rating list in association with the detected data records and/or references to the detected data records in a content module of the arithmetic and logic unit, for user accessibility.

29. The method of claim 25, further comprising:
periodically checking, by the arithmetic and logic unit, the variable mood quantities; and
if at least one of the mood quantities lies beyond a fixable fluctuation tolerance or a determinable expected value, saving and/or updating the corresponding rating lists with the detected data records and/or references to detected data records in the content module of the arithmetic and logic unit, for user accessibility.

30. The method of claim 25, further comprising:
generating, by a lexicographical rating data bank, at least one of the rating parameters.

31. The method of claim 25, further comprising:
dynamically generating, by the arithmetic and logic unit, at least one of the rating parameters during the generating of the rating list.

32. The method of claim 25, further comprising:
generating the fluctuating mood quantities and/or the data of the content module by at least one of HTML, HDML, WML, VRML, an ASD.

33. The method of claim 25, further comprising:
creating a user profile on the basis of user information, based on the saved detected data records and/or references to detected data records a the content module;
generating user specifically optimized data, by a repackaging module, according to the user profile; and
saving the user specifically optimized data in the content module of the arithmetic and logic unit.

34. The method of claim 33, further comprising:
saving and allocating to the user, by the arithmetic logic unit, different profiles for different communication devices of the user.

35. The method of claim 33, further comprising:
automatically registering user behavior data, by the arithmetic and logic unit; and
saving the user behavior data in association with the user profile.

36. The method of claim 25, further comprising:
saving, by a history module, the values for every computed mood fluctuation quantity up to a definable past time.

37. The method of claim 36, further comprising:
computing, by an extrapolation module of the arithmetic logic unit, expected values of determinable mood quantities based on the data of the history module for a determinable future time; and
saving the expectation values in the second memory of the arithmetic logic unit.

38. A system for aggregating and monitoring locally saved multimedia data, comprising:
a first memory for saving at least one search term;
source data banks linked to network nodes and bi-directionally linked with an arithmetic and logic unit over the network; and
the arithmetic and logic unit, the arithmetic and logic unit including:
a second memory configured to save at least one rating parameter, the rating parameter being allocated to a search term and/or a shortcut of search terms;
a filter module configured to generate a rating list of detected data records in at least one of predetermined source data banks, categories, and groups of data banks; and
a parameterization module configured to generate, based on the rating list according to a time-based appearance detection module, fluctuation mood quantities corresponding to time-based mood fluctuations in users of the network, based on the data records in at least one of the predetermined source data banks, categories, and groups of data banks for the respective rating parameter.

39. The system of claim 38, further comprising:
a trigger module configured to trigger a time-based entry and/or the probability of a time-based entry of an expected incident based on the time-based appearance of the detected data records in at least one of the predetermined source data banks, categories, and groups of data banks.

40. The system of claim 39, wherein the expected incident includes an anticipated class action.

41. The system according to claim 38, wherein the arithmetic and logic unit further comprises:
a lexicographical rating data bank configured to generate at least one of the rating parameters.

42. The system according to claim 38, wherein the arithmetic and logic unit further comprises:
a module configured to dynamically generate at least one of the rating parameters during the generation of the rating list.

43. The system according to claim 38, wherein the arithmetic and logic unit further comprises:
a content module configured to save the rating list with the detected data records and/or references to detected data records, for user accessibility.

44. The system according to claim 38, wherein the arithmetic and logic unit is configured to check the mood quantities periodically and, if at least one of the mood quantities lies beyond a fixable fluctuation tolerance or determinable expectation value, update the corresponding rating list with the detected data records and/or references to detected data records in the content module.

45. The system according to claim 38, wherein the arithmetic and logic unit further comprises a module configured to generate the fluctuating mood quantities and/or the data of the content module, by at least one of HTML, HDML, WML, VRML, and ASD.

46. The system according to claim 38, wherein the arithmetic and logic unit includes a user profile, with user information for every user, and further comprises:
a repackaging module configured to generate optimized user specific data according to the user profile, based on the detected data records and/or references to the detected data records, in the content module.

47. The system according to claim 46, wherein the arithmetic logic unit is configured to save, and allocate to the user, different profiles for different communication devices of the user.

48. The system according to claim 46, wherein the arithmetic logic unit is configured to automatically register user behavior data and allocate the user behavior data to the corresponding user profile.

49. The system according to claim 46, wherein the arithmetic logic unit further comprises:
a history module that includes, for every computed fluctuating mood quantity, the values up to a fixable past time in which the fluctuating mood quantities are accessible by the communication devices.

50. The system according to claim 49, wherein the arithmetic logic unit further comprises:
an extrapolation module configured to calculate expectation values of a future time that is determinable by the user.

51. A computer program product that can be installed on an internal storage unit of a digital computer including a program software code which enables the processes according to claim 25.
